(19) United States
(12) Patent Application Publication
(10) Pub. No.: US 2023/0411737 A1
(43) Pub. Date: Dec. 21, 2023

(54) H.K.O. ISOLIER- UND TEXTILTECHNIK GMBH

(71) Applicant: H.K.O. ISOLIER- UND TEXTILTECHNIK GMBH, Oberhausen (DE)

(72) Inventors: Ulrich STUDE, Rodeberg-Struth (DE); Carsten STÖCKMANN, Oberhausen (DE)

(21) Appl. No.: 18/038,584

(22) PCT Filed: Nov. 29, 2021
(86) PCT No.: PCT/EP2021/083349

§ 371 Date: May 24, 2023

(30) Foreign Application Priority Data
Dec. 1, 2020 (DE) 10 2020 007 327.1

(51) Int. Cl. H01M 10/658; H01M 10/653; H01M 50/249; H01M 50/204

(52) U.S. Cl. CPC H01M 10/658; H01M 10/653; H01M 50/249; H01M 50/204

(57) ABSTRACT

A multilayer protective element for thermal and electrical insulation of a battery, a battery having such a protective element, and the use of the protective element for preventing flame or spark leakage from a battery are proposed. The protective element has a carrier layer of a silicate fabric and a protective layer of phlogopite.

### CROSS-REFERENCE TO RELATED APPLICATIONS

The present application is a national stage application under 35 U.S.C. 371 of PCT Application No. PCT/EP2021/083349, filed 29 Nov. 2021, which designated the United States, which PCT application claimed the benefit of German Patent Application No. 10 2020 007 327.1, filed 1 Dec. 2020, each of which are incorporated herein by reference in their entirety.

### BACKGROUND

The present invention relates to a multilayer protective element for thermal and/or electrical insulation of a battery, a battery having a multilayer protective element, and a method for thermal and/or electrical insulation and/or fire protection of a battery.

In the present invention, the term “protective element” is preferably understood to mean a flat component with a layered structure, in particular a layer package, which is designed and/or used for the thermal and/or electrical insulation and/or other partitioning of a battery or its cells. In particular, the protective element is designed to reduce and/or delay the release of heat to the environment, in particular a vehicle interior, and/or to contain or reduce or delay the spread of heat in the battery in the event of uncontrolled or excessive heat generation in the battery.

In the present invention, the term “battery” is understood to mean a storage element or secondary element, in particular a rechargeable storage element, for providing electrical energy by converting chemical energy. The battery is preferably composed of a plurality of interconnected accumulator cells and/or cell blocks, i.e. battery cells.

In particular, the battery is designed as a traction battery and/or for driving electric vehicles and/or as a lithium-ion battery. Here, reliable and/or effective thermal insulation is important in order to protect the occupants of the vehicle in the event of overheating of the battery, for example as a result of a traffic accident, at least until the arrival of rescue forces and/or for a certain period of time, for example at least five minutes.

Lithium-ion batteries in particular exhibit comparatively high instability due to their chemical composition. If a local short circuit of the internal electrodes occurs in a battery cell, for example due to dendrite formation or contamination of a separator separating the electrodes by trapped foreign particles and/or due to mechanical action or damage, the strong short-circuit current heats the battery cell up to 800° C., sometimes up to 1300° C., in a short time. This process is known as thermal runaway. The thermal runaway of a battery cell can easily or quickly spread to other, neighbouring battery cells, in particular since the separator already loses stability at relatively low temperatures, for example above 120° C., and short circuits can therefore occur quickly in neighbouring battery cells. This leads to an unstoppable chain reaction, wherein the energy stored in the battery is released in a short time, usually explosively and/or with the release of toxic gases and the formation of flames and/or sparks. There is also a risk of the battery bursting if the internal pressure rises accordingly.

WO 2019/121641 A1 discloses a multilayer protective element for a battery for thermal insulation. The protective element has, in particular, mica layers as cover layers and a compressible, needled nonwoven as an intermediate layer, it being possible for the cover layers or an intermediate layer between nonwovens to be designed as a silicate fabric. To enable pressure equalisation in the event of fire or explosion, a housing of the battery has an outlet which is not covered by the protective element but is provided with a separate filter or valve.

EP 1 326 745 A1 relates to a laminate sheet material comprising a first layer comprised of polymeric material and a second layer comprised of non-metallic fibers. The laminate sheet material is useful for fire barrier applications on vehicles such as aircraft.

US 2018/0309107 A1 relates to a thermal insulation and/or electrical insulation and fire protection material for electrochemical battery cells, modules and packs, and electrochemical battery modules and packs including the thermal and/or electrical insulation and fire protection material.

WO 2020/070275 A1 relates to a fire protection device comprising a composite system comprising a backing layer, an adhesive layer and a fire protection layer which contains at least one ablative compound, and an envelope inside which the composite system is arranged.

DE 32 42 900 A1 relates to a thermal insulation with a double-walled housing for a high-temperature storage battery. The insulation is designed as a layered structure that is arranged and evacuated between an inner wall and an outer wall of the housing. In particular, the layered structure provides for more than 100 planar thin layers. The layers are preferably films of mica paper, although the films may also be partially formed of glass paper or ceramic paper. At least one intermediate layer serving as a spacer is arranged between every two successive layers. The intermediate layer can consist of a glass silk fabric layer or be formed by glass fiber paper or ceramic fiber paper. The residual gas pressure should be less than 0.1 mbar. Preferably, to produce the thermal insulation, the mica paper forming the layers is wound around the inner wall of the housing and an intermediate layer of glass silk fabric is inserted between every two successive layers of such a winding. For thermal insulation of a high-temperature storage battery whose storage cells are to be maintained at a constant temperature of 350° C., at least 500 layers of mica paper are to be provided. In the proposed structure, a total thickness of at most 35 mm can be realized, with each layer having a thickness of at most 15 μm, and the glass silk fabric layers or the glass fiber papers or ceramic papers each having a thickness of 20 μm. Thicker glass silk fabric layers or glass fiber papers or ceramic papers can also be used, but this will increase the total layer thickness.

Against this background, it is desirable to keep a battery cell that is located adjacent to a battery cell subjected to runaway and/or to an overheating battery cell as long as possible below a certain limit temperature, preferably of 120° C., in particular of 80° C. This is because above 80° C. the aging process of the battery cell is considerably accelerated and above 120° C. the separator in the battery cell often begins to melt, resulting in irreversible damage and/or short circuits. In addition, the electrolyte in the battery then also becomes gaseous and increases the internal pressure in the battery cell, ultimately causing the battery cell to burst.

Similarly, there is a high demand for efficient and/or long-lasting thermal protection of adjacent areas or spaces, in particular vehicle interiors, from the uncontrolled heat generation in the battery. In particular, occupants and/or objects should be protected from heat until rescue and/or recovery operations have been fully completed.

In addition, rescue workers should also be protected during rescue/recovery from uncontrolled explosions when the battery is subjected to runaway and the risk of toxic gases (for example gaseous hydrofluoric acid), sparks and flames escaping should be reduced. In particular, there is a risk that, if a battery is subjected to runaway, an electric arc can occur in the battery which very quickly melts the usually metallic housing, so that in this case the risk of flames and the like escaping, for example upwards into a vehicle interior, is very high.

### SUMMARY

Object of the present invention is to provide a multilayer protective element for thermal and/or electrical insulation of a battery, a battery with such a protective element and a method for thermal and/or electrical insulation and/or fire protection of a battery, wherein in the event of a fire and/or overheating and/or short circuit, an escape of flames and/or sparks can be delayed, minimized or even prevented.

The above object is solved by a multilayer protective element, by a battery or by a method as disclosed herein.

The proposed protective element serves in particular for thermal and/or electrical insulation and/or fire protection of a battery.

The proposed protective element preferably has a carrier layer and a protective layer, the carrier layer preferably being laminated with the protective layer, i.e. in particular being connected, bonded and/or glued flatly or firmly.

The carrier layer preferably has a fabric which, in particular, consists or is composed at least essentially of silicate fibers.

The silicate fibers are preferably finished with a metal oxide, in particular aluminium oxide.

The carrier layer and/or the fabric is or are preferably heat resistant above 1100° C., in particular above 1150° C., especially preferably above 1200° C.

The protective layer preferably consists at least essentially of a mineral and/or (electric) breakdown resistant protective material, in particular of one or more phyllosilicates, particularly preferably of phlogopite. The protective layer preferably has a high dielectric constant and/or a high dielectric strength.

The protective material is preferably heat resistant above 1000° C.

Particularly preferably, the carrier layer and/or the fabric of silicate fibers finished with a metal oxide, in particular aluminium oxide, is/are laminated with the protective layer, which contains phlogopite or consists at least essentially thereof. In this way, even with a preferred low thickness of in particular less than 2 mm, a particularly flexible protective element can be provided which can withstand both very high thermal and mechanical loads for a longer period of time, so that the particularly outer protective layer can provide effective protection against arcing and/or sparking in the battery for a longer period of time.

The more general inventive idea of using a heavy-duty fabric for mechanical and/or thermal protection in combination with a breakdown resistant and/or electrically insulating protective layer can be taken from the above-mentioned particularly preferred embodiment.

Particularly preferably, the carrier layer and/or the fabric is laminated on both sides with the protective layer. This results in universal applicability of the protective element regardless of its orientation and/or also between battery cells and/or between modules formed from a plurality of battery cells.

Another aspect of the present invention that can also be implemented independently is to combine the carrier layer comprising a fabric that is heat resistant above 1100° C. or 1150° C. with the protective layer consisting primarily of phlogopite or two protective layers consisting of phlogopite on both sides.

Experiments have shown that the proposed protective element and/or a battery with the proposed protective element in the interior of the battery housing and/or the use of the proposed protective element for thermal and/or electrical insulation and/or fire protection in the interior of a battery can better and/or longer withstand the extreme conditions during runaway of a battery to form an effective protection even with a minimal overall thickness of the protective element.

In particular, even at high temperatures above 1000° C.—at least for a sufficiently long time in the event of an accident or defect—the carrier layer can form a very effective, highly resilient mechanical protection, but also a thermal insulation and/or shielding, in particular of the protective layer. In this way, it can be achieved that the protective layer or its mineral material is protected from excessive heat input for a longer period of time in order to be able to perform its protective function for a correspondingly longer period of time, namely to form an electrical insulation and/or breakdown resistant barrier and, in particular, to provide additional thermal insulation. Thus, when runaway of the battery occurs, the protective element can in particular at least reduce or delay the heat impact and electrical impact on the housing and thus ultimately on the environment/surroundings, such as a vehicle or a vehicle interior.

The protective layer or its protective material preferably has a dielectric strength of more than 20 kV/mm, in particular more than 30 kV/mm, particularly preferably more than 40 kV/mm. This avoids or delays the formation of arcs or sparks.

The above-mentioned aspects and features of the present invention as well as the aspects and features of the present invention resulting from the claims and the following description can in principle be realized independently of each other, but also in any combination or sequence. Additional advantages, features, characteristics and aspects of the present invention will be apparent from the claims and the following description of a preferred embodiment with reference to the drawings.

### BRIEF DESCRIPTION OF THE DRAWINGS

FIG. 1A a schematic section of a proposed multilayer protective element;

FIG. 1B a schematic view of a carrier layer of the protective element;

FIG. 1C a schematic view of a potential adhesive layer of the protective element;

FIG. 2 a schematic section of a proposed battery with the protective element; and

FIG. 3 a schematic section of a vehicle with the proposed battery.

### DETAILED DESCRIPTION

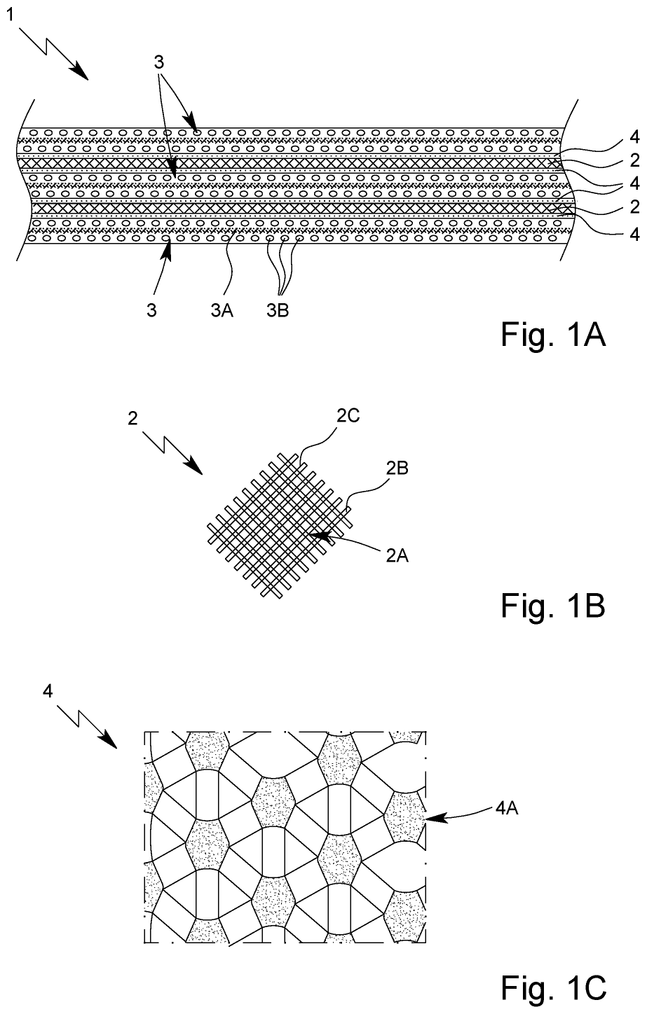

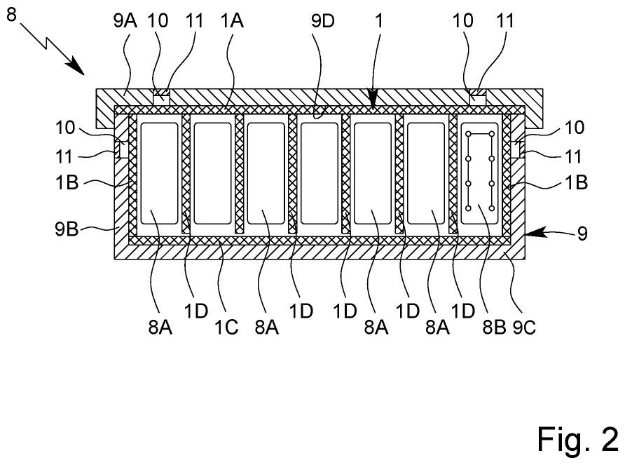

FIG. 1A shows a schematic, not to scale, sectional view of a proposed multilayer protective element 1. The protective element 1 is provided for in particular thermally and/or electrically insulating and/or shielding off or sealing off a proposed battery 8, which is shown in FIG. 2 in a schematic, not to scale, sectional view.

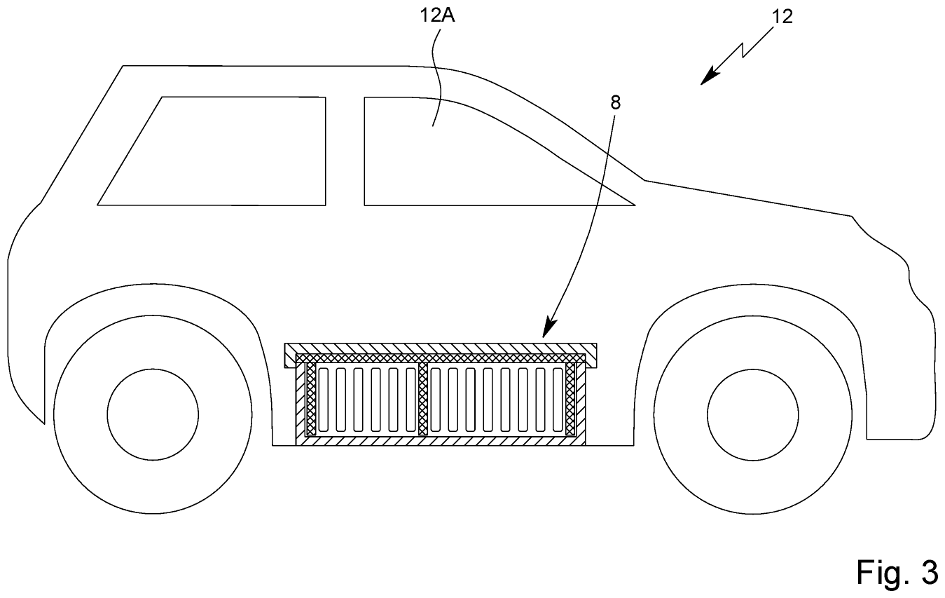

The battery 8 (accumulator) is designed in particular as a lithium-ion accumulator, and/or is provided for a vehicle 12, as indicated in FIG. 3. Particularly preferably, the battery 8 serves as a drive battery or traction battery for the vehicle 12, which is preferably designed as an electric car or electric vehicle.

However, the protective element 1/the present invention is also generally applicable or usable for the protection of batteries, e.g. in the medical field, in battery-powered electrical appliances, such as leaf blowers, hedge trimmers or brushcutters, and e.g. in the military or for other purposes, in particular for the protection of persons carrying batteries on or near the body.

In the following, a preferred structure of the protective element 1 is first discussed in more detail.

The protective element 1 has a carrier layer 2 and at least one protective layer 3.

Preferably, the carrier layer 2 is provided and/or laminated with the protective layer 3 on both sides.

In addition, the carrier layer 2 and the protective layer 3 can also be layered on top of each other multiple times. In the example shown, the protective element 1 has two carrier layers 2, so that the preferred double-sided lamination with the protective layer 3 results in the layer sequence protective layer 3, carrier layer 2, protective layer 3, carrier layer 2, protective layer 3.

The carrier layers 2 are preferably identically constructed, but can in principle also be constructed differently.

Preferably, the carrier layer 2 has or consists of a fabric 2A, as schematically indicated in FIG. 1B.

The fabric 2A is particularly preferably made of or composed of or consists of silicate fibers 2B, at least substantially.

The fabric 2A or fibers 2B may also be constructed of or consist of E-glass, C-glass, ECR-glass, S-glass, R-glass, fused quartz, silicate glass, ceramics, Al₂O₃, aluminium silicate, and/or mixtures thereof.

The fabric 2A may also be a glass fiber fabric, aramid fabric or carbon fiber fabric. It is also possible that the fabric 2A is a blended fabric or comprises or consists of a blend of, in particular, glass fibers, carbon fibers, aramid fibers, silicate fibers and/or the fibers mentioned in the previous paragraph.

Preferably, the fabric 2A and/or the fibers 2B have a silicate content of at least 90% by weight, particularly preferably at least 95% by weight, before and/or after finishing. This is conducive to the desired heat resistance.

Alternatively, the fabric 2A and/or the fibers 2B before and/or after finishing preferably have a silicate and/or Al₂O₃ content of more than 85% by weight, in particular more than 90% by weight, especially preferably more than 95% by weight. This is conducive to the desired heat resistance.

The fabric 2A preferably has a basis weight or grammage of more than 120 g/m², in particular more than 400 g/m², particularly preferably more than 500 g/m², and/or less than 2000 g/m², in particular less than 1500 g/m², particularly preferably less than 1000 g/m².

The weave of the fabric 2A is particularly preferably designed as a cross twill weave, but can also be designed in particular as a plain weave, twill weave, double weave, multiple weave, pointed twill weave and/or Panama weave.

The fabric 2A and/or the fibers 2B is/are preferably finished, i.e. provided with a surface modification or surface finish 2C, as only schematically indicated in FIG. 1B.

The preferred finish 2C particularly preferably leads to and/or is provided for an increase of the heat resistance, in particular above 1150° C., and/or an increase of the tensile strength, in particular to above 500 N/5 cm.

Ideally, a temperature resistance of 1200° C. of the fabric 2A and/or the fibers 2B for more than 5 minutes can be achieved by the appropriate finish 2C, in particular in the exemplary embodiment explained below, in which the fabric 2A and/or the fibers 2B have the aforementioned high silicate content and/or Al₂O₃ content.

The fibers 2B are preferably finished with a metal oxide, in particular aluminium oxide/Al₂O₃, and/or chloromethylisothiazolinone and preferably additionally with flame and/or fire retardants. The grammage of the finish 2C is preferably more than 10 g/m², in particular about 20 g/m 2 to 50 g/m², and/or less than 400 g/m², preferably less than 200 g/m², in particular less than 100 g/m².

The carrier layer 2 and/or the fabric 2A preferably has a thickness of less than 1 mm, particularly preferably less than 0.8 mm, and/or more than 0.5 mm.

The carrier layer 2 and/or the finished fabric 2A preferably has a grammage or basis weight of more than 500 g/m² and/or of less than 1000 g/m².

The silicate content and/or Al₂O₃ content of the fabric 2A, in particular after finishing (coating and/or surface modification), is preferably more than 90% by weight, in particular more than 95% by weight.

The carrier layer 2 and/or the fabric 2A before or after finishing preferably has a tensile strength of more than 300 N/5 cm, in particular more than 400 N/5 cm, particularly preferably more than 500 N/5 cm, most preferably more than 900 N/5 cm, in particular in each direction (warp and weft). The tensile strength (maximum tensile force) is preferably determined in accordance with ISO 4606:1995(E) at test piece lengths of 350 mm.

The protective layer 3 preferably contains a mineral protective material 3A and is particularly preferably at least essentially composed of or consists at least essentially of this protective material 3A, as schematically indicated in FIG. 1A.

The protective layer 3 preferably additionally has a fabric or scrim 3B that is provided with and/or carries the protective material 3A—on one or both sides. For example, the protective material 3A is (adhesively) bonded to the fabric/scrim 3B, e.g. by means of silicone, or is connected or applied in some other way.

The protective material 3A is preferably a mineral material, particularly preferably a sheet silicate or phyllosilicate, in particular mica, especially preferably phlogopite.

The fabric/scrim 3B preferably consists of glass, in particular E-glass, C-glass, ECR-glass, silicate glass or mixtures thereof.

The thickness of the protective layer 3 and/or of the protective material 3A is preferably more than 0.1 mm and/or less than 0.5 mm, in particular less than 0.3 mm, particularly preferably less than 0.2 mm.

The protective material 3A and/or protective layer 3 is preferably heat resistant above 1000° C.

The protective element 1 is preferably flexible. The thickness of the protective element 1 is preferably less than 2 mm, in particular less than 1.5 mm, and/or preferably more than 0.5 mm, in particular more than 1 mm.

The basis weight/grammage of the protective element 1 is preferably less than 2000 g/m², more preferably less than 1000 g/m², and/or more than 500 g/m², in particular more than 750 g/m².

The protective layer 3 and/or the protective material 3A preferably has a dielectric constant of more than 4, in particular more than 5, the determination being made in particular in accordance with IEC 62631-2-1:2018.

The protective layer 3 and/or the protective material 3A is preferably designed to be electric breakdown resistant. Breakdown resistant in the sense of the present invention means that the protective layer 3 and/or the protective material 3A has a dielectric strength of more than 20 kV/mm, in particular more than 40 kV/mm, particularly preferably more than 50 kV/mm.

The dielectric strength indicates the maximum electric field strength that may prevail in a material without voltage breakdown (arcing or sparking) occurring. The method for determining dielectric strength is defined in the IEC 60243-1:2013 series of standards. The measurement is carried out in particular under normal conditions between 20° C. and 25° C. and preferably at a relative humidity of about 50%.

Particularly preferably, the dielectric strength of the protective material 3A is greater than the dielectric strength of the protective element 1 and/or the high dielectric strength of the protective material 3A leads to a dielectric strength of a carrier layer 2 with a protective layer 3 of more than 10 kV/mm, in particular more than 20 kV/mm.

The protective layer 3 and/or its protective material 3A has or have in particular a comparative tracking index of more than 550 (CTI value measured according to IEC 60112:2020).

The carrier layer 2 and/or the fabric 2A is preferably laminated, i.e. connected, (adhesively) bonded or glued, over the entire surface with the associated protective layer 3, in particular by means of a bonding layer 4, as indicated schematically in FIG. 1A.

The bonding layer 4 may, for example, be formed by an adhesive film, a double-sided adhesive tape or the like.

In particular, a polyacrylate and optionally a scrim may be used or employed for bonding and/or forming the bonding layer 4.

The bonding or bonding layer 4 can optionally be designed as a partial adhesive bonding 4A, as indicated in FIG. 1C. Particularly preferably this is here a net-like application or arrangement of adhesive or bonding areas that connect/bond the carrier layer 2 to the protective layer 3. In this way, a partial or punctual surface connection/bonding of the carrier layer 2 to the protective layer 3 can be realized with high gas permeability, even if the carrier layer 2 is connected/bonded to the protective layer 3 on the surface or flat side.

Alternatively or additionally, a thermally unstable adhesive and/or a thermally unstable connection and/or connecting film can be used for the connection/bonding and/or adhesion in order to achieve high gas permeability at elevated temperatures, in particular at temperatures of more than 200° C., preferably more than 250° C., particularly preferably more than 300° C.

Particularly preferably, the carrier layer 2 and/the fabric 2A or each carrier layer 2 and/or each fabric 2A is laminated and/or provided on both sides with the protective layer 3.

The protective element 1 and/or the outer protective layer 3 optionally has an adhesive layer applied in particular only partially or punctiform and/or is designed to be self-adhesive in order to facilitate or enable the attachment or mounting of the protective element 1 to and/or in the battery 8 or its housing 9.

Preferably, at least the carrier layer 2 has such mechanical stability that no fragments can penetrate the protective element 1 and/or fabric 2A in the event of an explosion of the battery 8.

The protective element 1 and/or the protective layer 3 is preferably heat-resistant, in particular above 1000° C., although the connection/bonding and/or adhesion of the carrier layer 2 to the protective layer 3 need not exhibit this heat resistance.

The term “heat resistant” in the sense of the present invention preferably refers to the resistance and/or durability of a material or component to high temperatures and/or the mentioned/specified temperatures.

Preferably, the temperatures mentioned/specified for heat resistance represent minimum values of the melting temperature or, particularly preferably, lower limit values for 0.8 or 0.9 times the melting temperature and/or preferred upper usage temperatures in the sense explained below and/or refer in particular to the base material, i.e., in the case of the protective layer 3, in particular, to its protective material 3A or, in the case of the carrier layer 2, to its fabric 2A (in particular with sizing and/or finish 2C).

A material or component, in particular the protective element 1 and/or one of the layers 2, 3, is in particular heat-resistant (up to an upper usage temperature) in the sense of the present invention if it retains its properties up to this usage temperature—for example, the protective layer 3 and/or the protective material 3A retains its dielectric strength, for example, the carrier layer 2 and/or the fabric 2A retains its mechanical stability or shape, its strength or deformability, in particular its tensile strength or the like—or does not change to such an extent that it is no longer suitable for the desired application (here the shielding/sealing and/or damping and/or electrical and/or thermal insulation of the battery and/or battery cells).

Preferably, a material or component, in particular the protective element 1 and/or the layer 2 or 3, is heat-resistant if it or they meet the requirements of one of the insulating material classes according to DIN EN 60085:2008-08, in particular insulating material class F, H, N or R of this standard.

The protective element 1 is designed in particular as a two-dimensional layer package and/or is at the same time flexible or pliable or bendable.

By the terms “flexible” or “pliable” or “bendable” is preferably meant a low bending stiffness of the protective element 1, the bending stiffness being a measure of the resistance of an acting force to a bending deformation for a component and/or of the protective element 1.

The bending stiffness is preferably determined according to ISO 5628:2019. Preferably, for this purpose, a plate-shaped protective element 1 with a certain dimension, for example with a thickness of 1.5 mm and a size of 60 mm×40 mm, is clamped in a rotatable clamping device. The free end of the protective element 1 contacts a sensor of a load cell, via which a corresponding contact force is detected when the clamping device is rotated. In particular, the sensor engages/contacts the free end of the protective element 1 at a distance of 50 mm from the clamping point. The bending stiffness is determined in particular by the force measured at the sensor when the protective element 1 bends by 15°.

The protective element is considered to be flexible/pliable/bendable if it has a bending stiffness determined in the aforementioned manner of less than 10 N, preferably less than 5 N, in particular less than 1 N.

The fibers 2B preferably have an average diameter of at least 6 μm.

Preferably, the basis weight/grammage of the protective layer 3 is less than 1000 g/m², preferably less than 500 g/m², in particular less than 300 g/m², and/or more than 100 g/m², preferably more than 150 g/m².

Preferably, the basis weight/grammage of the protective element 1 is less than 1800 g/m², preferably less than 1500 g/m², in particular less than 1300 g/m², and/or more than 600 g/m², preferably more than 800 g/m², in particular more than 1000 g/m².

The protective element 1 preferably has—in particular in the delivery state—a thickness of less than 1.8 mm, preferably less than 1.5 mm, in particular between 0.8 and 1.3 mm.

Particularly preferably, the protective element 1 has a dielectric strength of more than kV/mm, preferably more than 20 kV/mm.

In the following, the proposed battery 8 and an arrangement and/or use of the proposed protective element 1, in particular of proposed protective elements 1A and 1B and optionally further proposed protective elements 1C and 1D or similar protective elements 1, in the battery 8 are explained with reference to FIG. 2.

The protective elements 1A-D can be identical or different.

In the following, the protective elements 1A to 1D are also referred to as first protective element 1A, second protective element 1B, third protective element 1C and fourth protective element 1D for the purpose of differentiation. However, this only serves to distinguish the different protective elements 1 and does not imply that, for example, if the third protective element 1C is provided, a second protective element 1B must also necessarily be present.

Preferably, for power supply, the battery 8 is arranged or installed in a vehicle 12, in particular an electric vehicle, shown schematically in FIG. 3. In particular, the battery 8 in the installed state is located below a vehicle interior 12A, for example a passenger or other interior area of the vehicle 12 and/or in the area of the vehicle floor.

The battery 8 preferably has a housing 9 with a housing upper part or housing lid or housing cover 9A and a housing lower part 9B. In particular, the housing lower part 9B here also comprises a housing base 9C.

The housing 9 preferably consists of a non-conductive material, for example plastic, or of metal.

The battery 8 is preferably designed as a rechargeable battery/accumulator, in particular a lithium-ion battery. Alternatively, the battery 8 can also be constructed or designed from or with as lithium iron phosphate, lithium cobalt oxide, lithium metal oxide, lithium ion polymer, nickel zinc, nickel metal, nickel cadmium, nickel hydrogen, nickel silver, nickel metal hybrid, all solid state, lithium air, lithium sulphur and similar systems and/or materials.

In particular, the battery 8 preferably has multiple or a group of battery cells 8A and/or optionally an electronic module 8B, which are in particular electrically interconnected and/or accommodated in the housing 9 or its interior 9D.

Preferably, at least one protective element 1, here a first protective element 1A, is preferably attached or fixed, preferably adhered/glued, above the battery cells 8A and/or above the electronics module 8B and/or in particular to the housing 9 and/or housing cover/lid 9A. The first protective element 1A closes and/or insulates the lower housing part and/or the battery 8 and/or its cells 8A, in particular on the upper side.

In this way, particularly efficient top-side thermal insulation and fire protection is achieved with respect to the housing wall and/or housing cover/lid 9A and thus the vehicle interior 12A, in particular in order to protect persons or objects located therein efficiently and/or long enough from uncontrolled heat generation in the battery 8 or flame or spark escape from the battery 8 and/or penetration of parts in the event of the battery 8 bursting.

The battery 8 and/or the housing 9 preferably has at least one outlet 10 which—at least in the event of fire and/or excessive heating and/or a sharp rise in pressure inside the battery 8—allows gas to escape from the battery 8 or the housing 9 to the outside and thus allows for pressure equalisation. In this way, the battery 8 can be prevented from exploding or bursting, in particular in the event of fire and/or a short circuit and/or overheating.

The outlet 10 is preferably arranged in the housing cover or housing lid 9A and/or on a top side of the battery 8 or the housing 9.

The battery 8 or the housing 9 preferably has several outlets 10 for the escape of gases and/or for pressure equalisation.

Preferably, the or each outlet 10 is closed or closable in principle and/or in the delivery state and/or in normal use or as far as necessary, in particular by means of a thermally unstable and/or non-pressure-stable element 11, particularly preferably by means of a bursting disc, or the like.

Instead of the bursting disc, for example, another element or valve can also be used as the closure element 11, which in principle closes the outlet 10 and opens it in the event of fire and/or in the event of a short circuit and/or overheating—preferably automatically as a function of pressure and/or temperature. However, other constructional solutions are also possible.

In particular, at least one first protective element 1A and at least one second protective element 1B are used, wherein the first protective element 1A closes and/or thermally insulates the housing interior on the top side and the second protective element 1B is arranged laterally on a housing side wall in the interior 9D.

Preferably, the second protective element 1B is attached or arranged, in particular transversely or perpendicularly, to the first protective element 1A and optionally connected to thereto or formed thereby.

Preferably, all side walls 9B of the battery 8 or of the housing 9 are provided or covered on the inside with second protective elements 1B, preferably also independently of outlets 10 formed therein.

Alternatively or in addition to the first protective element 1A and/or the second protective element 1B, the battery 8 may comprise a further or third protective element 1C, as exemplified in FIG. 2.

The third protective element 1C is preferably arranged opposite the first protective element 1A and/or on an underside or the bottom 9C in the housing interior 9D. Preferably, the underside or the bottom 9C is completely or fully covered by the third protective element 1C.

The protective elements 1A-C are preferably each arranged between a battery cell 8A/the battery cells 8A and/or the optional electronic module 8B, on the one side, and the housing 9, on the other side.

Preferably, in the battery 8 or the housing 9, the carrier layer 2 and/or the fabric 2A faces the battery cells 8A and/or the protective layer 3 faces the housing wall if the carrier layer 2 is laminated with the protective layer 3 on one side only.

Alternatively or in addition to the protective elements 1A-C, at least one (further or fourth) protective element 1D is preferably arranged between the battery cells 8A and/or the electronic module 8B, thereby thermally insulating or separating them from each other.

The battery cells 8A are preferably encased at least substantially completely and/or on all sides by one or more protective elements 1.

The protective element 1 can preferably also compensate for possible expansion of the cells during charging and/or ensure a most possible defined mechanical pretension over the service life of the battery 8. In this case, at least approx. 25 kPa is required in the delivery state. Over the service life, the pressure in the installed state may increase to a maximum of 250 kPa due to expansion of the cells 8A (swelling). These values vary depending on the cell type (round cell, pouch cell and prismatic cell) and can be adapted to customer requirements.

In particular, the protective elements 1 enclose and/or surround multiple or all of the battery cells 8A and/or the electronic module 8B on all sides and/or in particular in such a way that these are insulated from one another, shielded/sealed off and/or arranged in a damping manner in the housing 9. The protective element 1 thus preferably forms a bearing mat for the battery cell(s) 8A and/or the electronics module 8B. In addition to effective thermal insulation, in particular on all sides, this also enables robust and/or resistant mounting, since any shocks and/or vibrations are damped and/or absorbed by the compressible protective element 1.

The battery cells 8A are preferably—in groups or individually—at least substantially completely and/or surrounded on all sides by one or more protective elements 1, i.e. insulated or shielded/sealed off from one another in the battery 8.

It should be noted that the protective element 1 can in principle and in particular also when arranged between the battery cells 8A and/or the electronic module 8B—i.e. in particular when not arranged on the outside towards the housing 9—have an additional layer, such as a further fiber layer and/or another intermediate, separating or insulating layer as required.

Tests have shown that the proposed protective element 1 is suitable both for containing heat within the battery 8 and for top side and/or lateral side arrangement and/or insulation, i.e. in particular for thermal protection of adjacent vehicle interiors 12A.

Individual aspects of the present invention may be combined as desired, as mentioned above, but may also be implemented independently.

### LIST OF REFERENCE SIGNS

1(A, B, C, D) Protective element
2 Carrier layer
2A Fabric
2B Fiber
2C Finish
3 Protective layer
3A Protective material
3B Fabric/Scrim
4 Bonding layer/Connection layer
4A partial adhesive bonding
8 Battery
8A Battery cell
8B Electronics module
9 Housing
9A Housing cover/lid
9B Housing lower part
9C Housing base/bottom
9D Interior
10 Outlet
11 (Closure) element
12 Vehicle
12A Vehicle interior

1-12. (canceled)

13. A protective element for thermal and/or electrical insulation and/or fire protection of a battery,
wherein the protective element is multilayer and comprises at least one carrier layer and at least one protective layer,
wherein the carrier layer comprises a carrier layer fabric, the carrier layer fabric consisting at least essentially of silicate fibers finished, i.e. provided with a surface modification or surface finish, with a metal oxide,
wherein the protective layer comprises a mineral protective material, the mineral protective material being at least essentially phlogopite, and
wherein the carrier layer and/or the carrier layer fabric is laminated with the protective layer.

14. The protective element according to claim 13, wherein the carrier layer and/or the carrier layer fabric is heat-resistant above 1100° C.

15. The protective element according to claim 13, wherein the silicate fibers have a diameter of at least 6 micrometres.

16. The protective element according to claim 13, wherein the silicate fibers are finished with Al2O3.

17. The protective element according to claim 13, wherein the carrier layer fabric is laminated and/or bonded directly and/or on both sides to the protective layer.

18. The protective element according to claim 13, wherein the carrier layer fabric has a tensile strength of more than 900 N/5 cm.

19. The protective element according to claim 13, wherein the protective layer and/or the mineral protective material is heat-resistant above 800° C.

20. The protective element according to claim 13, wherein the protective layer comprises a protective layer fabric or scrim carrying the mineral protective material.

21. The protective element according to claim 12, wherein the carrier layer fabric has a silicate content and/or Al2O3 content of more than 85% by weight.

22. The protective element according to claim 13,
wherein the carrier layer fabric is a woven fabric which consists at least essentially of silicate fibers finished, i.e. provided with a surface modification or surface finish, with Al2O3,
wherein the protective layer comprises a protective layer fabric or scrim carrying the mineral protective material which is at least essentially phlogopite, and
wherein the carrier layer and/or the woven fabric is adhesively bonded with the protective layer.

23. A battery, comprising:
a plurality of battery cells and optionally an electronic module,
a housing, wherein the battery cells and optionally the electronic module are arranged in an interior space of the housing, and
a protective element arranged in the interior for thermal and/or electrical insulation and/or for fire protection of the battery,
wherein the protective element is multilayer and comprises at least one carrier layer and at least one protective layer,
wherein the carrier layer comprises a carrier layer fabric, the carrier layer fabric consisting at least essentially of silicate fibers finished, i.e. provided with a surface modification or surface finish, with a metal oxide,
wherein the protective layer comprises a mineral protective material, the mineral protective material being at least essentially phlogopite, and
wherein the carrier layer and/or the carrier layer fabric is laminated with the protective layer.

24. The battery according to claim 23,
wherein the carrier layer fabric is a woven fabric which consists at least essentially of silicate fibers finished, i.e. provided with a surface modification or surface finish, with Al2O3,
wherein the protective layer comprises a protective layer fabric or scrim carrying the mineral protective material which is at least essentially phlogopite, and
wherein the carrier layer and/or the woven fabric is adhesively bonded with the protective layer.

25. The battery according to claim 23, wherein the battery is a traction battery for an electric vehicle.

26. The battery according to claim 23, wherein the protective element is arranged between the housing on the one side and at least one battery cell and/or the electronic module on the other side.

27. The battery according to claim 23, with at least one of: the carrier layer and/or the carrier layer fabric is heat-resistant above 1100° C., or the protective layer and/or the mineral protective material is heat-resistant above 800° C.

28. The battery according to claim 23, wherein the silicate fibers have a diameter of at least 6 micrometres and/or are finished with Al2O3.

29. The protective element according to claim 13, wherein the carrier layer fabric is laminated and/or bonded directly and/or on both sides to the protective layer.

30. The protective element according to claim 13, wherein the carrier layer fabric has a tensile strength of more than 900 N/5 cm.

31. A method for thermal and/or electrical insulation and/or for fire protection of a battery, which has a plurality of battery cells and optionally an electronic module in an interior space of a common housing, comprising:
arranging a protective element in the interior space, the protective element being multilayer and comprising at least a carrier layer and a protective layer,
wherein the carrier layer comprises a carrier layer fabric, the carrier layer fabric consisting at least essentially of silicate fibers finished, i.e. provided with a surface modification or surface finish, with a metal oxide,
wherein the protective layer comprises a mineral protective material, the mineral protective material being at least essentially phlogopite, and
wherein the carrier layer and/or the carrier layer fabric is laminated with the protective layer.

32. The method according to claim 31,
wherein the carrier layer fabric is a woven fabric which consists at least essentially of silicate fibers finished with Al2O3,
wherein the protective layer comprises a protective layer fabric or scrim carrying the mineral protective material which is at least essentially phlogopite, and
wherein the carrier layer and/or the woven fabric is adhesively bonded with the protective layer.
